(19) United States
(12) Patent Application Publication
(10) Pub. No.: US 2020/0175022 A1
(43) Pub. Date: Jun. 4, 2020

(54) DATA RETRIEVAL

(71) Applicant: Microsoft Technology Licensing, LLC, Redmond, WA (US)

(72) Inventors: Sebastian NOWOZIN, Cambridge (GB); Cheng ZHANG, Cambridge (GB); Noam KOENIGSTEIN, Ra'anana (IL); Chao MA, Cambridge (GB); Jose Miguel Hernandez LOBATO, Cambridge (GB); Wenbo GONG, Cambridge (GB)

(21) Appl. No.: 16/357,321

(22) Filed: Mar. 18, 2019

(30) Foreign Application Priority Data
Nov. 30, 2018 (GB) 1819520.6

(51) Int. Cl. G06F 16/2457; G06N 20/00

(52) U.S. Cl. CPC G06F 16/24578; G06N 20/00

(57) ABSTRACT

In various examples there is a data retrieval apparatus. The apparatus has a processor configured to receive a data retrieval request associated with a user. The apparatus also has a machine learning system configured to compute an affinity matrix of users for data items. The affinity matrix has a plurality of observed ratings of data items, and a plurality of predicted ratings of data items. The processor is configured to output a ranked list of data items for the user according to contents of the affinity matrix.

### CROSS-REFERENCE TO RELATED APPLICATION(S)

This non-provisional utility application claims priority to UK patent application number 1819520.6 entitled “DATA RETRIEVAL” and filed on Nov. 30, 2018, which is incorporated herein in its entirety by reference.

### BACKGROUND

Data retrieval systems for retrieving data items from the internet, intranets, databases and other stores of data items are increasingly desired since the amount of data items potentially available to end users is vast and it is extremely difficult to retrieve relevant data items in an efficient manner which reduces burden and time for the end user. Often users have to enter a query comprising key words by speaking the query or entering it using another modality into a data retrieval system. However, it is often difficult for end users to know what query to use. Also, end users have the burden of inputting the query to the computing system. Often the retrieved results from the data retrieval system are not relevant or are not the results the end user intended which is frustrating for the end user. In such situations it is often difficult for the end user to find a solution to the problem and the end user is unable to retrieve relevant data.

The embodiments described below are not limited to implementations which solve any or all of the disadvantages of known data retrieval apparatus.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

In various examples there is a data retrieval apparatus. The apparatus has a processor configured to receive a data retrieval request associated with a user. The apparatus also has a machine learning system configured to compute an affinity matrix of users for data items. The affinity matrix has a plurality of observed ratings of data items, and a plurality of predicted ratings of data items. The processor is configured to output a ranked list of data items for the user according to contents of the affinity matrix.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a data retrieval apparatus connected to a communications network together with various data stores, and various end user computing devices;

FIG. 2 is a schematic diagram of the data retrieval apparatus of FIG. 1 in more detail;

FIG. 3 is a schematic diagram of an example of the machine learning system of FIG. 2 in more detail;

FIG. 4 is a schematic diagram of another example of the machine learning system of FIG. 2 in more detail;

FIG. 5 is a flow diagram of a method of training the machine learning system of FIG. 3 or FIG. 4;

FIG. 6 is a flow diagram of another method of training the machine learning system of FIG. 3 or FIG. 4;

FIG. 7 is a flow diagram of a method performed by the data retrieval apparatus; and

FIG. 8 illustrates an exemplary computing-based device in which embodiments of a content editor are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example are constructed or utilized. The description sets forth the functions of the example and the sequence of operations for constructing and operating the example. However, the same or equivalent functions and sequences may be accomplished by different examples.

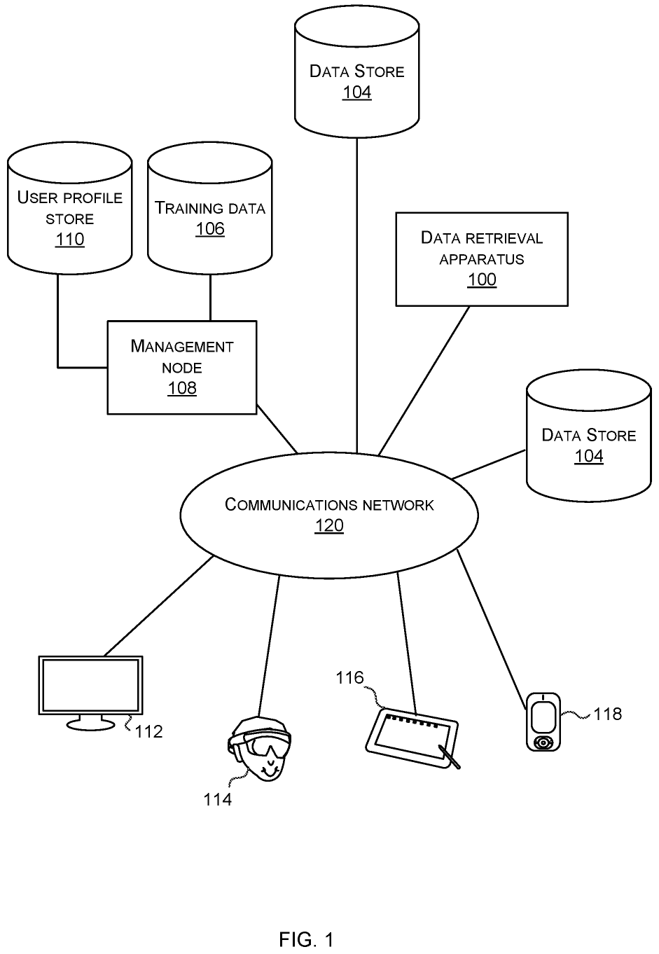

FIG. 1 illustrates a data retrieval apparatus 100 deployed as one or more web servers or other computing devices connected to a communications network 120. The data retrieval apparatus works to retrieve data items from one or more data stores 104 connected to the communications network 120. The data items are any files, documents, videos, books, images or other data items. The data retrieval apparatus 100 operates to identify data items which are relevant to individual users and so is able to return a ranked list of data items for an individual user. The data stores 104 are any databases, or stores holding data items.

The data retrieval apparatus 100 receives data retrieval requests where those requests comprise an identifier of a user. The data retrieval requests are received at the data retrieval apparatus 100 over the communications network 120 either directly from an end user computing device, or from a management node 108. FIG. 1 shows a variety of different end user computing devices which send data retrieval requests to the data retrieval apparatus 100. The end user computing devices include but are not limited to: an internet television 112, a head worn augmented reality computer 114, a tablet computer 116, a smart phone 118. In some examples, a management node 108 receives data retrieval requests from one or more of the end user computing devices 112-118 and it forwards the request to the data retrieval apparatus 100. The management node 108 has a store 110 of user profiles and in some cases, it adds user profile data to the data retrieval request before forwarding the data retrieval request to the data retrieval apparatus 100. However, it is not essential to use user profiles.

The data retrieval apparatus 100 has access to training data 106 such as training data 106 in a store connected to management node 108 of FIG. 1 or training data stored at any other location accessible to the data retrieval apparatus 100. The training data comprises observed ratings, where a rating is a relative score actively assigned by a user to an item or inferred from actions associated with the user, such as presentation of the data item, selection of the data item, download of the data item, or other action. There are a plurality of users, such as several thousands or millions of users. There are a plurality of data items such as several thousands or millions of data items. However, many of the ratings are missing, that is, less than 10% of the potential ratings are available in the training data. The total number of potential ratings is equal to the number of users times the number of data items.

As mentioned above, a rating is a relative score assigned by a user to an item or inferred from user behavior in connection with the item. In an example, a rating is either 1 or zero depending on whether a user selected the data item or not when presented with the data item in a graphical user interface. In an example, a rating is a number of stars that a user selected in connection with a data item, or a category that a user selected in connection with a data item.

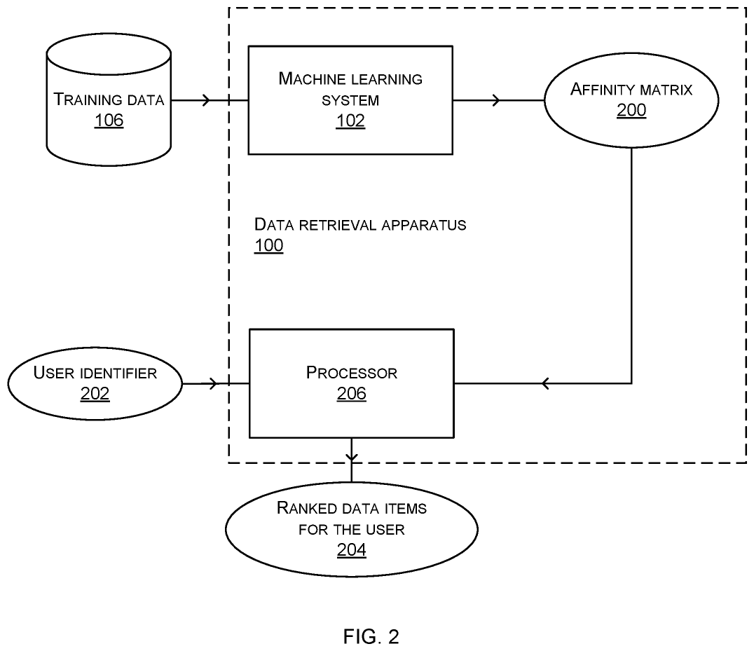

The data retrieval apparatus is described in more detail with reference to FIG. 2. The data retrieval apparatus 100 has a machine learning system 102 which computes an affinity matrix 200. The affinity matrix 200 is used by a processor 206 of the data retrieval apparatus 100 to output ranked data items 204 relevant for particular users. An affinity matrix is stored in the form of an array, table or grid comprising rows and columns (any other equivalent form is useable for the affinity matrix). Individual rows represent individual users and individual columns represent individual data items or vice versa. Cells of the array, table or grid represent a particular user and data item combination according to the position of the cell in the array, table or grid. A cell stores a rating which is numerical or categorical and represents an affinity of the user for the data item. Optionally the cells also hold uncertainty of the rating as described in more detail later. The affinity matrix is populated using observed ratings available in the training data and thus most of the cells of the affinity matrix are initially empty. A task of the machine learning system 102 is to predict ratings to fill the unseen entries of the affinity matrix.

The machine learning system 102 comprises at least a generative model which generates ratings and is able to generate predictions of the missing ratings which are missing from the training data. The machine learning system 102 is a non-linear model with parameters the values of which are updated using a training objective function during training of the machine learning system 102 using the training data.

The machine learning system 102, once trained using the training data 106, is used to generate predictions of the missing ratings which are missing from the training data. Together the observed ratings (available in the training data) and the predicted ratings fill an affinity matrix 200 representing affinity of users for the data items. The affinity matrix in some cases is a table with one row for each user and one column for each data item. Each cell in the table holds either an observed rating (from the training data) or a predicted rating (predicted by the machine learning system 102). The rows and columns of the affinity matrix are interchanged in some examples. That is, in some cases there is one row for each data item and one column for each user.

Note that the way of learning the affinity matrix 200 is different from previous technology, where either a simple linear model is used, or a non-linear and non-probabilistic method is used. More details are given below. The machine learning system 102 uses a principled probabilistic and non-linear approach to predict the missing ratings and also gives uncertainty information of the predicted missing ratings As a result accuracy of the present technology is better than for previous technology and thus more relevant data items are retrieved for users. Empirical data demonstrating the improvement in accuracy is given later in this document.

The data retrieval apparatus 100 receives as input a user identifier 202 such as by receiving the user identifier 202 in a data retrieval request. A processor 206 of the data retrieval apparatus 100 receives the user identifier 202 and looks up from the affinity matrix 200 predicted ratings for the identified user. The predicted ratings are ranked such as by ranking them from highest to lowest whilst ignoring the uncertainty information, or by ranking them in a manner which takes into account the uncertainty information. A ranked list or an truncated ranked list of data items 204 is output by the processor 206 according to the ranked predicted ratings. The ranked list of data items 204 is sent direct to an end user associated with the user identifier, or is sent to the management node for onward routing to the appropriate end user. The end user then has a ranked list of data items which are relevant to him or her and is able to quickly and simply review the ranked list and decide which one or more of the data items to select for further processing such as display at the end user computing device, download, or other processing.

The machine learning system operates in an unconventional manner to achieve prediction of missing ratings of the affinity matrix, despite having sparsely observed ratings from users. In this way there is a better data retrieval system.

The machine learning system improve the functioning of the underlying computing device by predicting missing ratings of the affinity matrix to enable better data retrieval, despite having sparsely observed ratings from users.

Notation is now explained which will be used later in this document. The training data comprises the ratings of M items from N users. Let rₙₘ be the rating given by the n^{th} user to the m^{th} item, and rₙ=r^{O}ₙ∪r^{U}ₙ is the partially observed rating vector for the n^{th} user with observed entries denoted as r^{O}ₙ and missing ones denoted as r^{U}ₙ. Where user profiles and data item metadata is available the following notation is used for the user profile uₙ and item features iₘ.

A goal of the data retrieval system is to retrieve interesting unseen data items for specified users. This is done based on efficient and accurate predictions of the missing ratings r^{U}ₙ given the observed ratings r^{O}ₙ and, if available, the meta information (comprising user profiles and/or data item metadata). A goal of the data retrieval system may be expresses mathematically as to infer the probability of the missing ratings, given the observed ratings, and given the user profiles and data item metadata if available: p(r^{U}ₙ|r^{O}ₙ, {iₘ}_{1≤m≤M}). For simplicity, the following description omits the index n for rₙ and drops uₙ, iₘ whenever the context is clear.

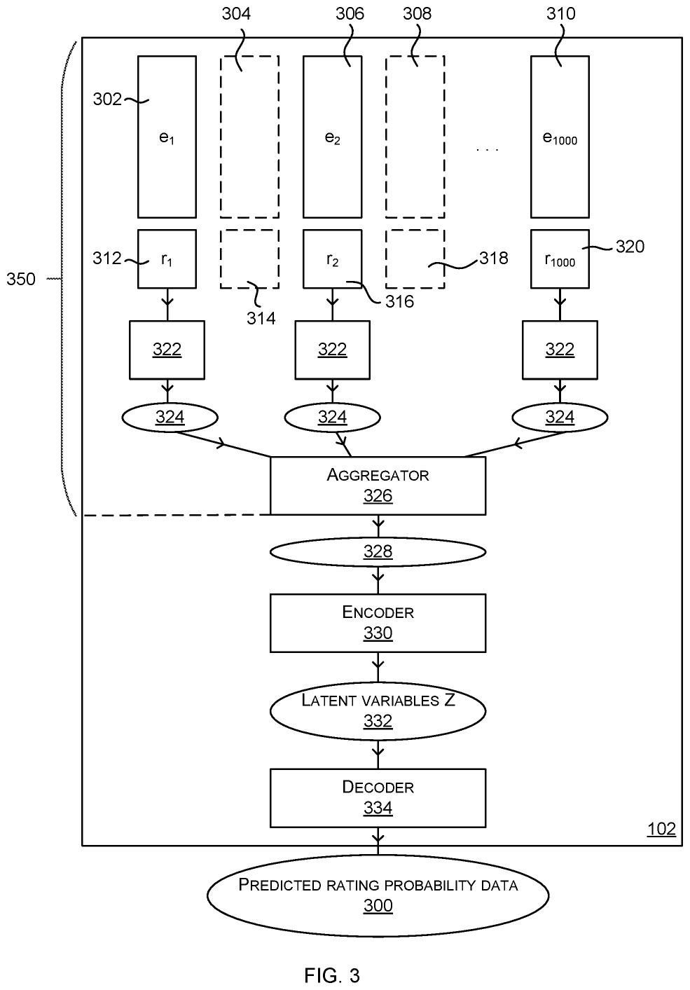

FIG. 3 is an example of the machine learning system 102 in more detail. It comprises a generative model referred to in FIG. 3 as a decoder 334. The decoder is part of a variational autoencoder comprising encoder 330 and decoder 334. The variational autoencoder is referred to as a partial variational autoencoder because it is able to deal with partial observations which are the observed ratings of the training data (these are partial observations since many of the potential ratings are missing from the training data). There are different numbers of observed ratings for different ones of the data items, and so the partial variational autoencoder is designed to be able to cope with inputs of varying length.

A variational autoencoder is a type of non-linear model comprising an encoder which encodes examples from a high dimensional space by compressing them into a lower dimensional space of latent variables 332 (denoted by symbol Z in FIG. 3). A decoder takes the encoded examples as input and generates predictions 300. The encoder and decoder are trained using machine learning in order that the predictions of the decoder are as similar to the inputs to the encoder. The encoder 330 thus takes an input of a known fixed size in order that the decoder predicts an output of the same known fixed size.

A regular variational autoencoder (VAE) uses a generative model (decoder 334) p(r, z)=p(r|z)p(z) that generates observations r given latent variables z, and an inference model (encoder 330) q(z|r) that infers the latent state z 332 given fully observed ratings r. Training VAE is very efficient through optimizing a variational bound. However, in the present technology, there are a huge number of possible partitions {U, O}, where the size of observed ratings might vary. This makes classic variational approaches to train a such a generative model no longer workable. Thus, VAE uses a deep neural network, namely an encoder network, as a function estimator for the variational distribution. However, traditional neural networks cannot handle missing data, thus VAE cannot be applied directly to predict missing ratings of the affinity matrix.

A naïve approach is to manually input the missing r^{U} with a constant value (such as zero, or a mean value of the observed ratings) has drawbacks including that it cannot differ between missing values and actually observed values. It also introduces additional bias. This poses learning difficulties and potential risks of poor uncertainty estimations, since rating data is typically extremely sparsely observed. Where the missing ratings are manually input with a constant value, the parameterization of the encoder neural network is inefficient and does not make use of the sparsity of rating data.

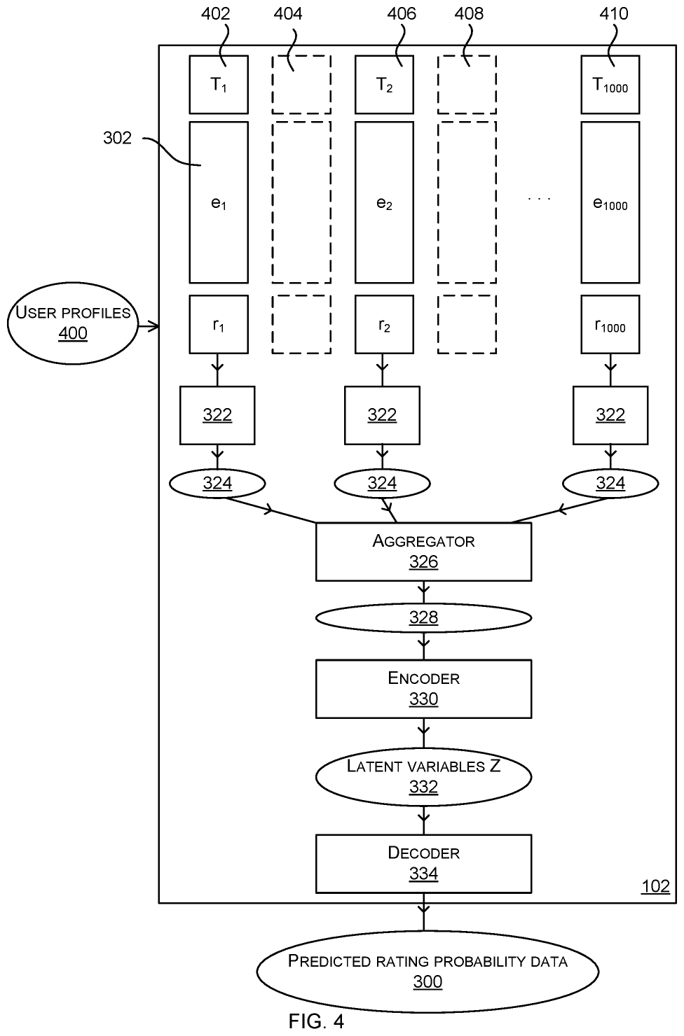

The present technology uses a partial VAE (p-VAE) as illustrated in FIG. 3 and FIG. 4. P-VAE assumes a latent variable model p(r)=∫_{z}p(r|z)p(z), where z is the latent variable. Notice the factorized structure for p(r|z), i.e.

$$p ( r \vert z ) = {\prod }_{i} {p}_{i} ( {r}_{i} \vert z ) .$$

Which is expressed in words as the probability of the ratings given the latent variables z of the encoder is equal to the aggregation over data items, of the probability of the ratings of a data item given the latent variables z of the encoder.

This implies that given z, the observed ratings r^{O} are conditionally independent of r^{U}. Therefore, inferences about r^{U} can be reduced to p)(z|r^{O}). Once knowledge about z is obtained, it is possible to draw correct inferences about r^{U}. To approximate p(z|r^{O}) an auxiliary variational inference network q(z|r^{O}) used (comprising the encoder and decoder of FIG. 3 or FIG. 4) and trained with the following partial variational upper bound as the training objective,

D_{KL}(q(z|r^{O})∥p(z|r^{O}))= [symbol] _{z˜q(z|r}_{^{O}}₎[log q(z|r^{O})−log p(z|r^{O})]≤ [symbol] _{z˜q(z|r}_{^{O}}₎[log q(z|r^{O})−log p(r^{O}|z)−log p(z)]≡

[symbol]

This bound, [symbol] ₚ, depends only on the observation r^{O}. The size of r^{O} could vary between different data points. The above training objective is expressed in words as upper bound [symbol] ₚ is equivalent to the expectation over the latent variables Z of the difference between the logarithm of a probability distribution represented by the encoder and the logarithm of a probability distribution represented by the decoder.

The inventors have recognized that a variational autoencoder is a potentially useful mechanism to predict missing ratings which are missing from the training data. However, in order to achieve this, the variational autoencoder has to be modified to allow for inputs to the encoder 330 which are not of a fixed length. To do this, a partial inference network 350 is included in the machine learning system 102 and used to compute the input to the encoder 330.

The partial inference network 350 is used to approximate the distribution q(z|r^{O}) by a permutation invariant set function encoding, given by:)

c(r^{O}):=g(h(s₁), h(s₂), . . . , h(s_{|O|}))

where |O| is the number of the observed ratings, sₘ carries the information of the rating and item identity. For example, sₘ=[eₘ, rₘ] or sₘ=eₘ*rₘ. Here, eₘ is an identity vector of the mth item. There are many ways to define eₘ under different settings, such as by using the meta information, or optimizing eₘ from scratch during learning when the meta information is not available. In the example of FIG. 4 eₘ is the concatenation of the fixed meta information that comes with the item data and the user profile, and a learnable set of identity embeddings. In the examples for which empirical data is described herein sₘ=eₘ*rₘ is used. The mapping functions h are implemented using mapping neural networks as now explained.

Each function h is implemented using aa neural network h(·) 322 to map input s from [symbol] ^{D+1} to [symbol] ^{K}, where D is the dimension of each eₘ, and rₘ is a scalar, K is the latent space size. Aggregator 326 is a permutation invariant aggregation operation g(·), such as max-pooling or summation. In this way, the mapping c(r^{O}) is invariant to permutations of elements of r^{O} and r^{O} can have arbitrary length. Finally, the fixed-size code c(r^{O}) is fed into an ordinary amortized inference network, that transforms the code into the statistics of a multivariate Gaussian distribution to approximate p(z|r^{O}). In practice, since the dimension of item feature iₘ often satisfies D<<M, this parameterization of encoder is very efficient compared with typical VAE approaches, which requires a huge M×K weight matrix. As a result the machine learning system is scalable to very large web-scale operation.

Additionally, we also propose the mimic the prediction procedure during the training. In particular, instead of using all the observed ratings r^{O} for the encoder q(z|r^{O}), we random sample a subset of it while use the whole set of r^{O} for the generative model (the decoder). In this way, we mimic the prediction procedure which is to use some observed value to predict some unseen values. Such modification during training has demonstrate performance gain on prediction accuracy of the unobserved ratings.

As mentioned above, the partial inference network 350 comprises an aggregator 326 which is symmetric and acts to aggregate predictions 324 from a plurality of mapping neural networks 322 into an output 328 of known fixed length suitable for input to the encoder 330. The parameters of neural networks 322 are shared among different items. However, the item identity embedding e is learned separately for each item. Each mapping neural network 322 takes as input an identity embedding of one of the data items (denoted using symbol e in FIG. 3), and the observed ratings (denoted using symbol r in FIG. 3) of the data item from many different users. In FIG. 3 the identity embeddings 302, 306, 310 are denoted by the symbol e and the observed ratings are denoted by the symbol r. The identity embeddings 302, 306, 310 are latent variables which are learnt by the machine learning system and have the same length. The observed ratings r are held in vectors and these vectors are of different lengths due to the fact that there are different numbers of observed ratings for the different data items. In the example of FIG. 3 some of the data items have no observed ratings available (denoted in FIG. 3 using dotted lines 314, 318) and the corresponding identity embeddings are shown using dotted lines 304, 308. Each mapping neural network acts to map its inputs from a high dimensional space to a lower dimensional space which has the same number of dimensions at the space of the latent variables Z produced by the encoder 330. The outputs of each mapping neural network is a vector in the lower dimensional space and which has the same length for each mapping neural network. However, the total number of ratings that are observed for each user varies thus, the number of vectors differ.

The aggregator 326 is a max-pooling operator, or a summation operator, or any other permutation invariant aggregator. Therefore the aggregator 326 is invariant to permutations of its input elements, thus the vectors r can have arbitrary length. The output of the aggregator 326 is a fixed length vector 328 of known size referred to as a fixed-size code) c(r^{o}).

The fixed-size code c(r^{o}) is input to the variational autoencoder which computes predicted rating probability data 300 as output.

In the example of FIG. 3 no user profile data is used and no metadata about the content items is used. FIG. 4 is the same as FIG. 3 except that it shows how user profile data is used where it is available and how data item metadata is used where it is available.

Where data item metadata is available it is concatenated to the input vectors of the mapping neural networks. In the example of FIG. 4, data item 1 has metadata T₁ 402 which is concatenated to identity embedding vector e₁ for the data item 1. Data item 2 has metadata T₂ 406 which is concatenated to identity embedding vector e₂ for the data item 2. Data item 1000 has metadata T₁₀₀₀ 410 which is concatenated to identity embedding vector e₁₀₀₀ for the data item 1000. Concatenating the metadata in this way is a simple and efficient way to enable it to be taken into account by the machine learning system. For data items that have no observed ratings the data item metadata is indicated in FIG. 4 using dotted lines 404, 408.

Where user profile data is available (at the consent of users) such as an age range of the user, or a gender of the user, it is incorporated into the rating vectors r before input to the mapping neural networks. In some cases user profile data is concatenated to the fixed size code output by the aggregator.

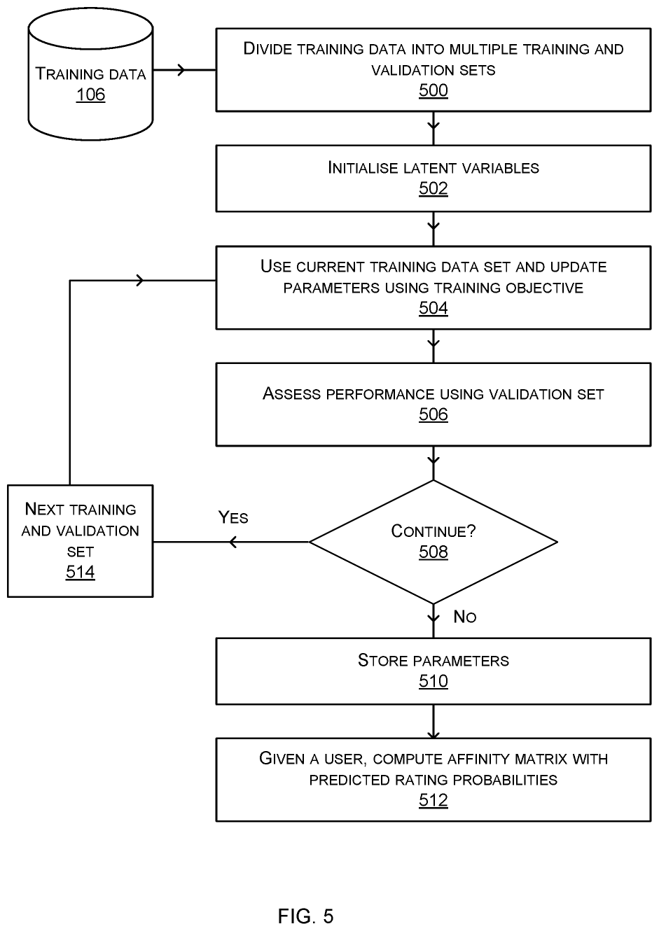

FIG. 5 is a flow diagram of a method of training the machine learning system of FIG. 3 or FIG. 4. Training data 106 is available comprising observed ratings for a small proportion (such as 5%) of possible combinations of thousands of users and thousands of data items. The training data is divided into multiple training and validation sets 500 and latent variables of the machine learning system are initialized, such as by setting them to random values.

A current one of the training and validation sets is selected. The current training set is used to train 504 the machine learning system by populating the observed ratings into the vectors for input to the mapping neural networks and running the machine learning system in a forward pass to compute predicted rating probability data 300. The output of the decoder is compared with the inputs to the mapping neural networks using a training objective which is set out below. The parameters of the mapping neural networks, the identity embeddings, the parameters of the encoder, the parameters of the decoder and the latent variables Z are all updated according to the training objective.

The performance of the machine learning system is assessed 506 by comparing the predicted ratings against the known observed ratings in the validation set. If the performance is below a threshold then training continues by taking the next training and validation set 514 and returning to operation 504.

If the performance is above a threshold, or if there are no more training and validation sets, the training ends and the parameters of the machine learning system are stored 510. The trained parameters of all neural networks are stored 510. Given a user query, the affinity matrix with the predicted rating probability is computed efficiently.

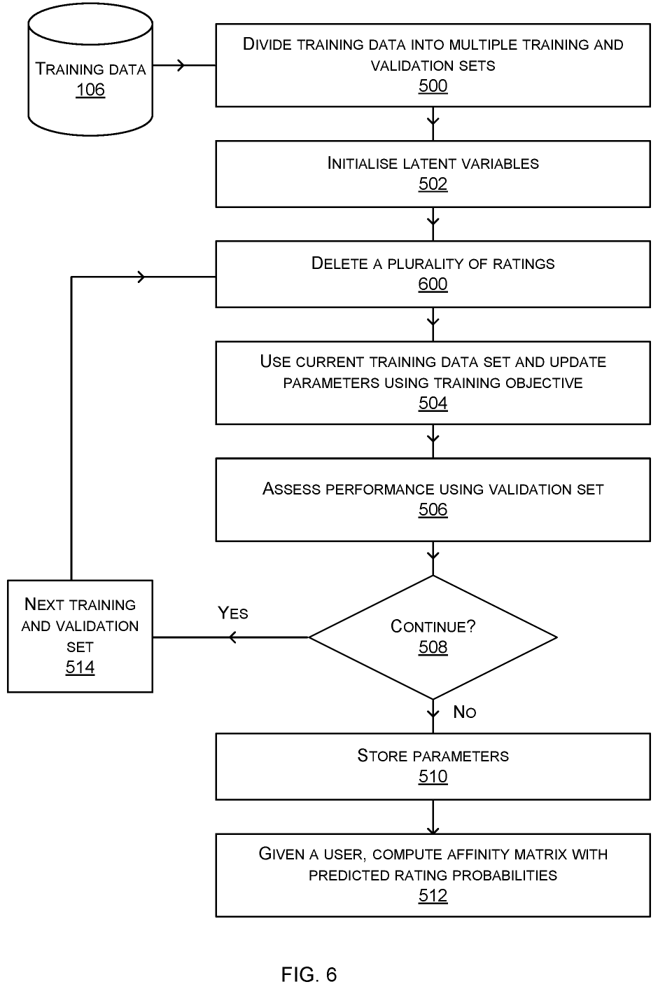

In some examples the training process is adapted as shown in FIG. 6 in order to improve the generalization ability of the machine learning system. FIG. 6 is the same as FIG. 5 except that a plurality of the observed ratings are deleted 600 from the training data set for training the encoder but the whole training set is used for training the decoder. It is found that deleting a proportion of the observed ratings, such as 50% of the observed ratings for training the encoder and training the decode using the whole observed rating set gives improved accuracy of the trained machine learning system. The ratings to be deleted are selected at random.

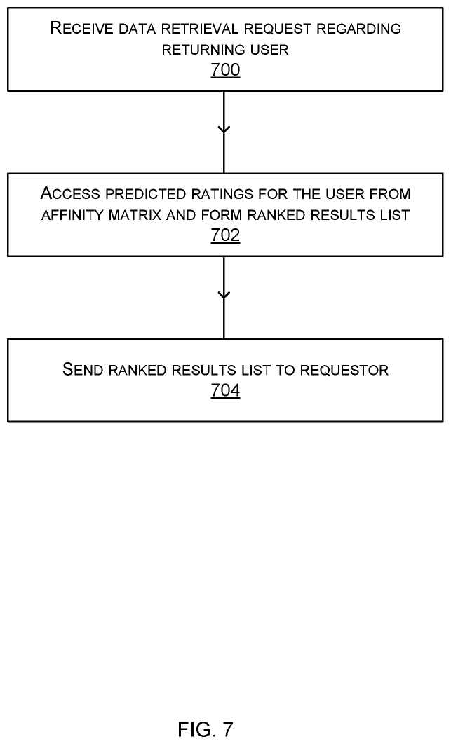

The method of FIG. 7 acts to mimic the prediction procedure during training. In particular, instead of using all the observed ratings r^{O} for the encoder q(z|r^{O}), a random sample of the observed ratings is used for the encoder, while the whole set of r^{O} observed ratings is used to train the generative model (the decoder). In this way, the process mimics the prediction procedure which is to use some observed values to predict some unseen values. Such modification during training is found to give a performance gain on prediction accuracy of the unobserved ratings.

With reference to FIG. 7, once the affinity matrix has been populated with at least some predicted ratings, it is used by the data retrieval system to retrieve data items for users. The data retrieval system receives 700 a data retrieval request from a returning user. It accesses 702 predicted ratings for the user from the affinity matrix and forms a ranked results list. The data retrieval system sends the ranked results list to the requestor, such as an end user computing device or management node 108 of FIG. 1.

The present technology has been tested using a well known dataset comprising 1000206 rating records of 3952 movies by 6040 users. The dataset is large and sparsely observed since only around 5% of the potential ratings are observed. A 90%/10% training-test ratio was used to split the dataset into training and validation data sets. The number of latent dimensions of the latent variable Z was 20. The number of hidden layers was one for each of the neural networks (encoder, decoder and mapping neural networks). The number of hidden units was 500 for each of the encoder and decoder. The learning rate was 0.001 with Adam and there were ten training epochs. The rating data ranges from 1 to 5 and sigmoid activation functions were used for the output layer of the decoder, multiplied by a scaling constant equal to 5. The following results are taken as the average of five different runs.

The root mean square error (RMSE) was 0.84 for the present technology All other previous probabilistic approaches gave a RMSE of 0.85 or higher, including where missing ratings are manually completed with zeros.

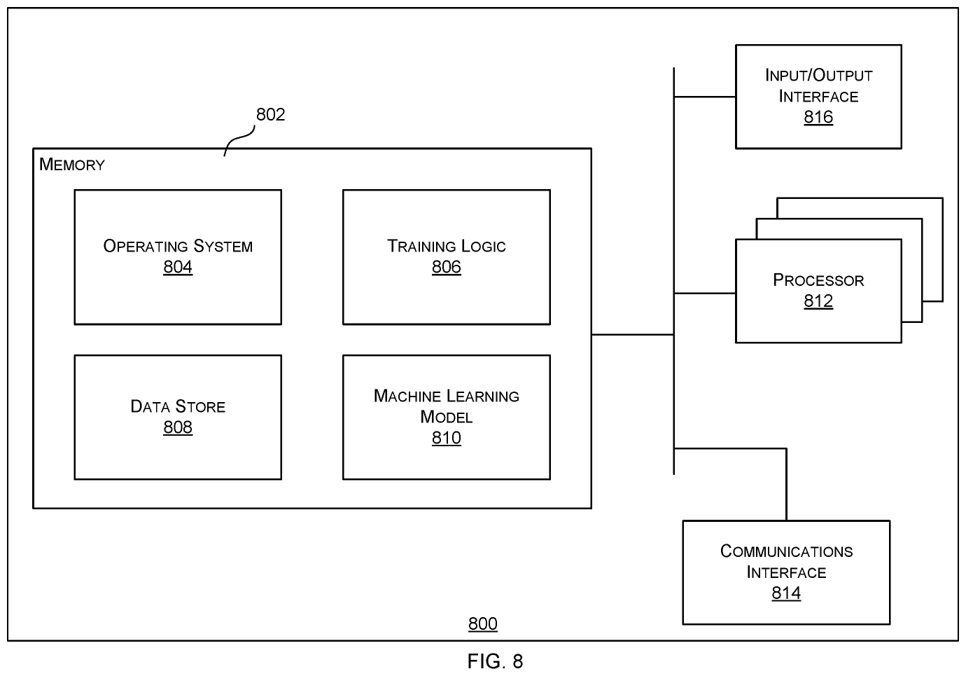

FIG. 8 illustrates various components of an exemplary computing-based device 800 which are implemented as any form of a computing and/or electronic device, and in which embodiments of a data retrieval apparatus are implemented in some examples.

Computing-based device 800 comprises one or more processors 812 which are microprocessors, controllers or any other suitable type of processors for processing computer executable instructions to control the operation of the device in order to retrieve content items by predicting ratings of content items by users. In some examples, for example where a system on a chip architecture is used, the processors 812 include one or more fixed function blocks (also referred to as accelerators) which implement a part of the method of training a machine learning system, and/or using a trained machine learning system to predict ratings, in hardware (rather than software or firmware). Platform software comprising an operating system 804 or any other suitable platform software is provided at the computing-based device to enable machine learning model 810 and training logic 806 to be executed on the device. The machine learning model 810 is as described with reference to FIGS. 3 and 4 and the training logic implements a training scheme such as that described with reference to FIGS. 5 and 6. A data store 808 holds training data, parameter values, latent variables and other data.

The computer executable instructions are provided using any computer-readable media that is accessible by computing based device 800. Computer-readable media includes, for example, computer storage media such as memory 802 and communications media. Computer storage media, such as memory 802, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 802) is shown within the computing-based device 800 it will be appreciated that the storage is, in some examples, distributed or located remotely and accessed via a network or other communication link (e.g. using communication interface 814).

The computing-based device 900 also comprises an input/output interface 816 arranged to output display information to a display device which may be separate from or integral to the computing-based device 800. The display information may provide a graphical user interface. The input/output interface 816 is also arranged to receive and process input from one or more devices, such as a user input device (e.g. a mouse, keyboard, camera, microphone or other sensor). In some examples the user input device detects voice input, user gestures or other user actions and provides a natural user interface (NUI). This user input may be used to select change representations, view clusters, select suggested content item versions. In an embodiment the display device also acts as the user input device if it is a touch sensitive display device. The input/output interface 816 outputs data to devices other than the display device in some examples.

Alternatively or in addition to the other examples described herein, examples include any combination of the following:

Clause A. An data retrieval apparatus comprising:

a processor configured to receive a data retrieval request associated with a user;

a machine learning system configured to compute an affinity matrix of users for data items, the affinity matrix comprising a plurality of observed ratings of data items, and a plurality of predicted ratings of data items; and

wherein the processor is configured to output a ranked list of data items for the user according to contents of the affinity matrix. By having predicted ratings of data items in the affinity matrix, the accuracy of the data retrieval system is high which enables highly relevant data items to be retrieved. There is no need to make ad hoc assumptions about missing ratings. The data retrieval apparatus is scalable to web-scale operation because of the scalability of the machine learning system.

Clause B The data retrieval apparatus of clause 1 wherein the affinity matrix stores uncertainty information about the uncertainty of individual ones of the predicted ratings. By computing and storing uncertainty information about the predicted ratings the accuracy of the data retrieval system is improved. Previously uncertainty information has not been available.

Clause C The data retrieval apparatus of clause 1 wherein the machine learning system comprises a non-linear model. By using a non-linear model an efficient and accurate way of predicting the unobserved ratings is given.

Clause D The data retrieval apparatus of clause 1 wherein the machine learning system has been trained using historical observed ratings of data items. By training the machine learning system its ability to predict accurately is facilitated.

Clause E The data retrieval apparatus of clause 1 wherein the machine learning system has been trained using historical observed ratings of data items and without user profile data. The ability to train without using user profile data is advantageous where user profile data is unavailable or cannot be used.

Clause F The data retrieval apparatus of clause 1 wherein the machine learning system has been trained using historical observed ratings of data items and without semantic data about the content of the data items. The ability to train without semantic data about the content of the data items brings efficiencies whilst still giving a good working solution.

Clause G The data retrieval apparatus of clause 1 wherein the machine learning system comprises a variational autoencoder adapted to take as input partially observed variables of varying length being the observed ratings of data items. In this way the ability of the data retrieval apparatus to operate in a wide range of situations is facilitated. Thus varying numbers of observed ratings are handled in a principled way.

Clause H The data retrieval apparatus of clause 1 wherein the machine learning system comprises, for each data item having an available observed rating, an identity embedding which is a latent variable learnt by the machine learning system. Since the identity embeddings are learnt there is no need to use semantic data about the content of the data items.

Clause I The data retrieval apparatus of clause 8 wherein the machine learning system comprises, concatenated to each identity embedding, observed ratings of the associated data item. Using concatenation in this way is a simple and efficient method of enabling the identity embeddings and observed ratings to be input to the machine learning system.

Clause J The data retrieval apparatus of clause 8 wherein the machine learning system comprises, for each identity embedding, a mapping neural network configured to map an identity embedding from a multi-dimensional space of the identity embeddings to a multi-dimensional space of a variational autoencoder. The mapping neural networks are an efficient way of mapping to a suitable size of multi-dimensional space in order to work with the autoencoder.

Clause K The data retrieval apparatus of clause J wherein the mapping neural networks share parameters. Sharing parameters in this way reduces the burden of storing and/or training the mapping neural networks.

Clause L The data retrieval apparatus of clause J wherein the machine learning system comprises an aggregator configured to aggregate the outputs of the mapping neural networks into a fixed length output. The aggregator thus facilitates connection of the autoencoder to the mapping neural networks.

Clause M The data retrieval apparatus of clause L where the aggregator is symmetric. By using a symmetric aggregator the order of the ratings in the rating vectors input to the mapping neural networks does not matter. Also, training of the machine learning system is facilitated.

Clause N The data retrieval apparatus of clause L wherein the machine learning system takes into account user profiles by concatenating user profile data to the output of the aggregator. Concatenating user profile data is an efficient and effective way of taking into account the user profile data.

Clause O The data retrieval apparatus of clause J wherein the machine learning system takes into account data item metadata by concatenating data item metadata onto the identity embeddings. Concatenating data item metadata is an efficient and effective way of taking into account the data item metadata.

Clause P The data retrieval apparatus of clause 1 wherein the machine learning system has been trained using an upper bound which depends only on the observed ratings. The upper bound gives an effective and practical way of training the machine learning system.

Clause Q A computer-implemented method of data retrieval comprising:

receiving a request comprising an identifier of a user;

retrieving predicted ratings for the user from an affinity matrix representing affinity of users for data items, the affinity matrix comprising a plurality of observed ratings of data items, and a plurality of predicted ratings of data items, where the predicted ratings have been computed using a machine learning system; and

outputting a ranked list of data items on the basis of the retrieved predicted ratings. The result is highly relevant data item retrieval achieved in an efficient manner.

Clause R The method of clause Q comprising computing the affinity matrix using a partial variational autoencoder. Using a partial variational autoencoder is an accurate and efficient way of predicting unobserved ratings to populate the affinity matrix.

Clause S The method of clause Q comprising computing the affinity matrix by training the machine learning system using a training objective function comprising a upper bound which depends only on the observed ratings. Using the upper bound is an effective way of training the machine learning system.

Clause T A computer-implemented method of data retrieval comprising:

receiving a request comprising an identifier of a user;

computing an affinity matrix using machine learning, the affinity matrix representing affinity of users for data items, the affinity matrix comprising a plurality of observed ratings of data items and a plurality of predicted ratings of data items; and

retrieving predicted ratings for the user from the affinity matrix;

outputting a ranked list of data items on the basis of the retrieved predicted ratings. The result is highly relevant data item retrieval achieved in an efficient manner.

Clause U A computer-implemented method of data retrieval comprising:

receiving a request comprising an identifier of a user;

computing an affinity matrix using machine learning, the affinity matrix representing affinity of users for data items, the affinity matrix comprising a plurality of observed ratings of data items and a plurality of predicted ratings of data items; and

retrieving predicted ratings for the user from the affinity matrix;

outputting a ranked list of data items on the basis of the retrieved predicted ratings; wherein computing the affinity matrix using machine learning comprises approximating a probability distribution over ratings given latent variables of a variational autoencoder, by using a plurality of mapping neural networks, one for each of a plurality of data items having observed ratings, to map an identity embedding of the data item and observed ratings of the data item into the same number of dimensions as the latent variables of the autoencoder; and by aggregating the outputs of the mapping neural networks into a fixed size code for input to the variational autoencoder; and using a generator of the variational autoencoder to predict a distribution over the ratings including the unobserved ratings.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. An data retrieval apparatus comprising:
a processor configured to receive a data retrieval request associated with a user;
a machine learning system configured to compute an affinity matrix of users for data items, the affinity matrix comprising a plurality of observed ratings of data items, and a plurality of predicted ratings of data items; and
wherein the processor is configured to output a ranked list of data items for the user according to contents of the affinity matrix.

2. The data retrieval apparatus of claim 1 wherein the affinity matrix stores uncertainty information about the uncertainty of individual ones of the predicted ratings.

3. The data retrieval apparatus of claim 1 wherein the machine learning system comprises a non-linear model.

4. The data retrieval apparatus of claim 1 wherein the machine learning system has been trained using historical observed ratings of data items.

5. The data retrieval apparatus of claim 1 wherein the machine learning system has been trained using historical observed ratings of data items and without user profile data.

6. The data retrieval apparatus of claim 1 wherein the machine learning system has been trained using historical observed ratings of data items and without semantic data about the content of the data items.

7. The data retrieval apparatus of claim 1 wherein the machine learning system comprises a variational autoencoder adapted to take as input partially observed variables of varying length being the observed ratings of data items.

8. The data retrieval apparatus of claim 1 wherein the machine learning system comprises an encoder and a decoder having been trained using training data and wherein the decoder is trained using more of the training data than the encoder.

9. The data retrieval apparatus of claim 1 wherein the machine learning system comprises, for each data item having an available observed rating, an identity embedding which is a latent variable learnt by the machine learning system.

10. The data retrieval apparatus of claim 9 wherein the machine learning system comprises, concatenated to each identity embedding, observed ratings of the associated data item.

11. The data retrieval apparatus of claim 9 wherein the machine learning system comprises, for each identity embedding, a mapping neural network configured to map an identity embedding from a multi-dimensional space of the identity embeddings to a multi-dimensional space of a variational autoencoder.

12. The data retrieval apparatus of claim 11 wherein the mapping neural networks share parameters.

13. The data retrieval apparatus of claim 11 wherein the machine learning system comprises an aggregator configured to aggregate the outputs of the mapping neural networks into a fixed length output.

14. The data retrieval apparatus of claim 13 where the aggregator is symmetric.

15. The data retrieval apparatus of claim 13 wherein the machine learning system takes into account user profiles by concatenating user profile data to the output of the aggregator.

16. The data retrieval apparatus of claim 11 wherein the machine learning system takes into account data item metadata by concatenating data item metadata onto the identity embeddings.

17. The data retrieval apparatus of claim 1 wherein the machine learning system has been trained using a upper bound which depends only on the observed ratings.

18. A computer-implemented method of data retrieval comprising:
receiving a request comprising an identifier of a user;
retrieving predicted ratings for the user from an affinity matrix representing affinity of users for data items, the affinity matrix comprising a plurality of observed ratings of data items, and a plurality of predicted ratings of data items, where the predicted ratings have been computed using a machine learning system; and
outputting a ranked list of data items on the basis of the retrieved predicted ratings.

19. The method of claim 18 comprising computing the affinity matrix using a partial variational autoencoder.

20. A computer-implemented method of data retrieval comprising:
receiving a request comprising an identifier of a user;
computing an affinity matrix using machine learning, the affinity matrix representing affinity of users for data items, the affinity matrix comprising a plurality of observed ratings of data items and a plurality of predicted ratings of data items; and
retrieving predicted ratings for the user from the affinity matrix;
outputting a ranked list of data items on the basis of the retrieved predicted ratings.
